(19) United States
(12) Patent Application Publication
(10) Pub. No.: US 2005/0244716 A1
(43) Pub. Date: Nov. 3, 2005

(54) Lithium-ion secondary battery and method of charging lithium-ion secondary battery

(75) Inventors: Kazuya Ogawa, Tokyo (JP); Tsuyoshi Iijima, Tokyo (JP); Satoshi Maruyama, Tokyo (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 11/090,172

(22) Filed: Mar. 28, 2005

(30) Foreign Application Priority Data
Mar. 31, 2004 (JP) P2004-105191

(51) Int. Cl. H01M 2/16; H01M 10/44

(52) U.S. Cl. 429/247; 429/50

(57) ABSTRACT

A lithium-ion secondary battery comprises a positive electrode collector having a surface provided with a positive electrode active material layer containing a positive electrode active material; a negative electrode collector having a surface provided with a negative electrode active material layer containing a negative electrode active material; an electrically insulating porous separator; and an electrolytic solution containing a lithium salt and infiltrating the separator. The negative electrode active material layer carries 2.0 to 6.0 mg/cm² of the negative electrode active material. The separator has a porosity of 45% to 90% and a Gurley air permeance of less than 200 s/100 cm³.

### BACKGROUND OF THE INVENTION

1. Field of the Invention

The present invention relates to a lithium-ion secondary battery and a method of charging the same.

2. Related Background Art

Along with recent dissemination and development of various portable devices, lithium-ion secondary batteries have been desired to further improve their characteristics. One of the characteristics expected to improve is the capacity keeping ratio after repeating a number of cycles of charging and discharging.

There have conventionally been proposals for improving the capacity keeping ratio, for example, by optimizing active materials (Japanese Patent Application Laid-Open No. H 10-236809) and by thinning electrodes so as to increase the opposing area of positive and negative electrodes while shortening the ion migration distance within the electrodes (Japanese Patent Application Laid-Open No. 2002-231312).

### SUMMARY OF THE INVENTION

Recently, rapid (high-rate) charging such as constant current/constant voltage charging at 10 C or higher or constant voltage charging has been proposed in order to shorten charging time. However, it has been found that the capacity keeping ratio after cycles of charging/discharging is likely to deteriorate remarkably when the above-mentioned rapid charging is performed in conventional lithium-ion secondary batteries such as those mentioned above.

In view of the problem mentioned above, it is an object of the present invention to provide a lithium-ion secondary battery yielding a sufficiently high capacity keeping ratio even when rapidly charged, and a method of charging this lithium-ion secondary battery.

As a result of diligent studies, the inventors have found that the capacity keeping ratio after cycles of charging/discharging can be made sufficiently high even when rapid charging is performed in the case where (1) the carried amount of a negative electrode active material disposed on a negative electrode collector falls within a predetermined range while (2) the air permeance and porosity of a separator fall within predetermined ranges, thereby achieving the present invention.

The lithium-ion secondary battery in accordance with the present invention comprises a positive electrode collector having a surface provided with a positive electrode active material layer containing a positive electrode active material; a negative electrode collector having a surface provided with a negative electrode active material layer containing a negative electrode active material; an electrically insulating porous separator; and an electrolytic solution containing a lithium salt and infiltrating the separator. The positive and negative electrode collectors are arranged so as to oppose each other such that the positive and negative electrode active material layers hold the separator therebetween.

The negative electrode active material layer carries 2.0 to 6.0 mg/cm² of the negative electrode active material. The separator has a porosity of 45% to 90% and a Gurley air permeance of less than 200 s/100 cm³.

Here, the Gurley air permeance is the gas permeance of a porous body defined in JIS (Japanese Industrial Standard) P8117.

The porosity is a value obtained when the volume of the pore part of the separator is divided by the combined volume of the pore and solid parts of the separator.

Thus configured lithium-ion secondary battery is less likely to deteriorate its capacity after cycles of charging/discharging even when charged rapidly. This enables constant voltage charging, for example, whereby portable devices and the like can improve their convenience.

The reason why the lithium-ion secondary battery of the present invention exhibits such a characteristic is not clear. However, it seems to be because of the fact that, since the negative electrode active material is carried less than that in conventional lithium-ion secondary batteries, the area of the interface between the active material and electrolytic solution is substantially enlarged, so that the Li concentration polarization decreases within the negative electrode active material layer, whereby lithium ions are less likely to be deposited as dendrite on the negative electrode; and because of the fact that the separator has physical properties falling within predetermined ranges, whereby lithium ions are allowed to migrate sufficiently and evenly.

Preferably, in this lithium-ion secondary battery, the positive electrode active material layer carries 4.0 to 11.0 mg/cm² of the positive electrode active material.

Rapid charging can favorably be performed when the lithium-ion secondary battery is charged with a set current value corresponding to 10 C. or higher.

Rapid charging can favorably be performed also when the lithium-ion secondary battery is subjected to constant voltage charging at 4.2 V.

The present invention can realize a lithium-ion secondary battery which is less likely to deteriorate its capacity greatly after cycles of charging/discharging even when charged rapidly.

### DESCRIPTION OF THE PREFERRED EMBODIMENTS

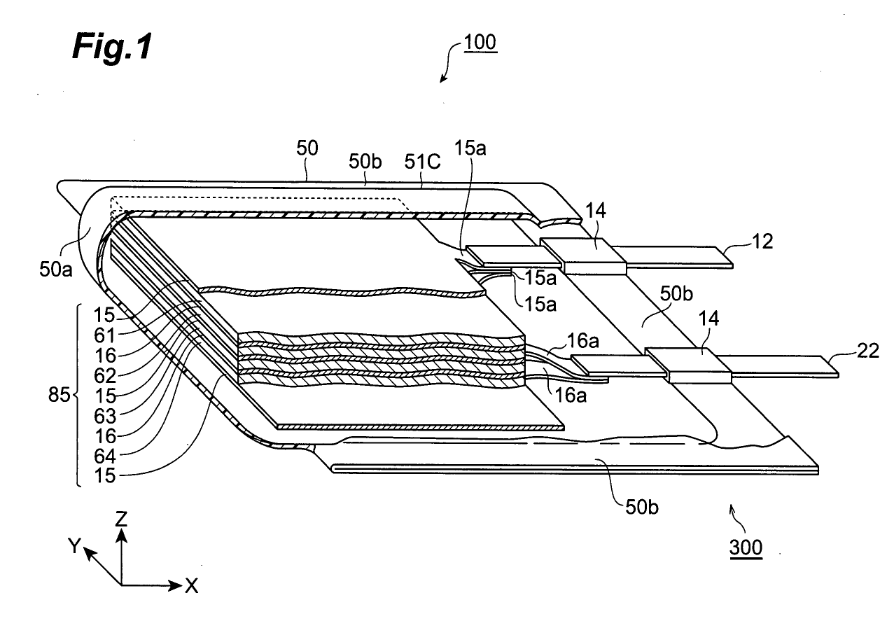

FIG. 1 is a partly broken perspective view showing the lithium-ion secondary battery in accordance with an embodiment;

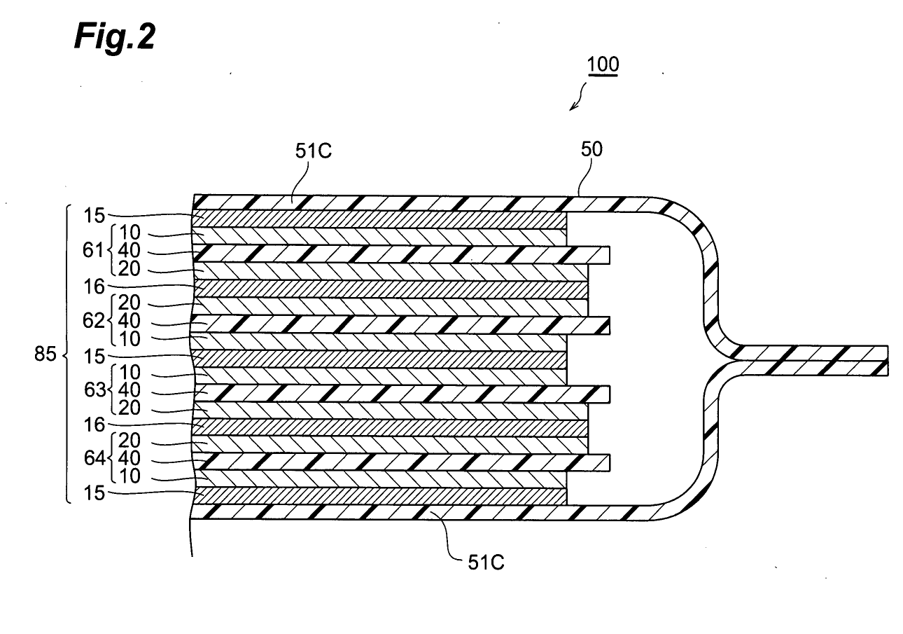

FIG. 2 is a sectional view of the lithium-ion secondary battery taken along the YZ plane of FIG. 1;

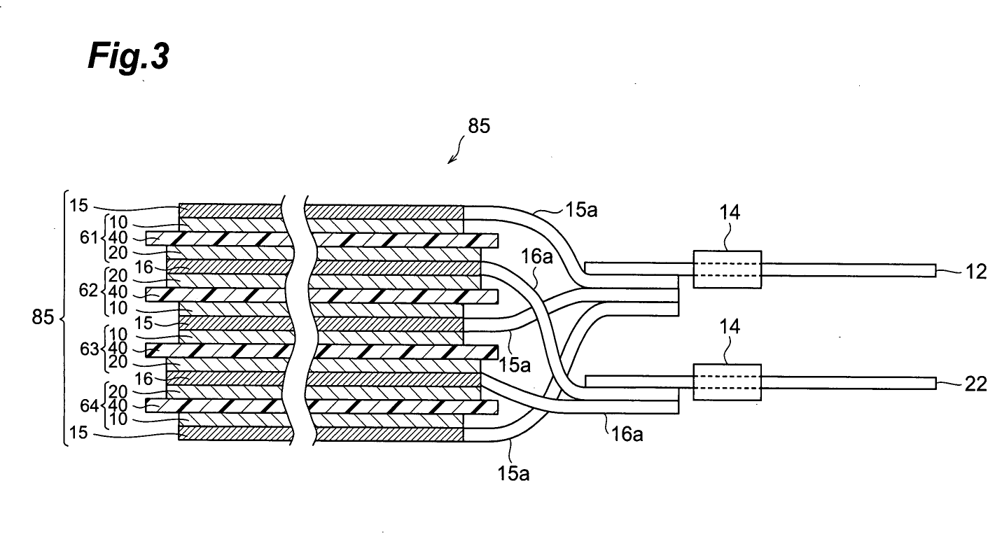

FIG. 3 is a view of the lithium-ion secondary battery as seen along the XZ plane of FIG. 1;

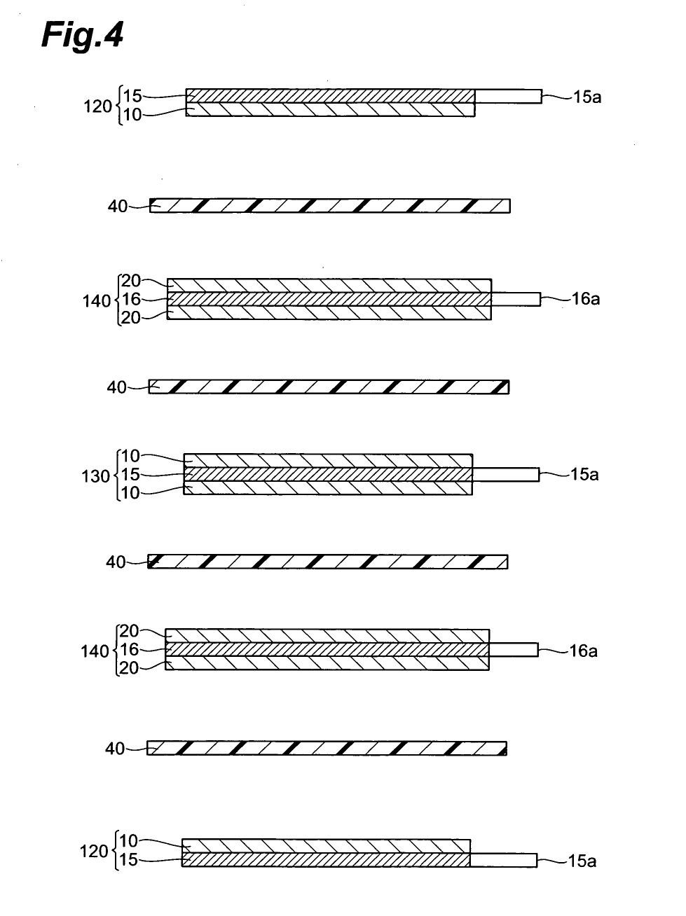

FIG. 4 is a sectional view showing a step of making the lithium-ion secondary battery of FIG. 1;

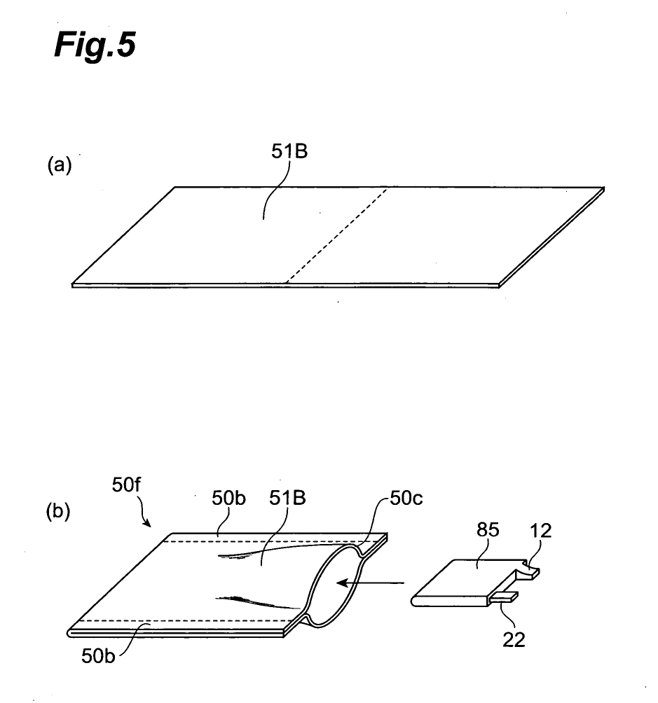

FIG. 5 is perspective views showing a method of manufacturing the lithium-ion secondary battery; and

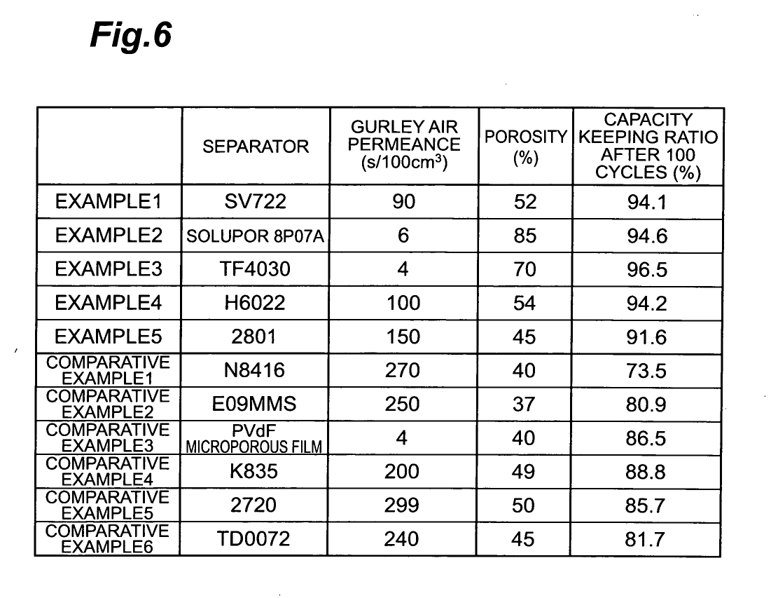

FIG. 6 is a table showing conditions and results of Examples 1 to 5 and Comparative Examples 1 to 6.

### DESCRIPTION OF THE PREFERRED EMBODIMENTS

### First Embodiment

First, an embodiment of the lithium-ion secondary battery in accordance with the present invention will be explained in detail.

FIG. 1 is a partly broken perspective view showing a lithium-ion secondary battery 100 in accordance with a first embodiment of the present invention. FIG. 2 is a sectional view taken along the YZ plane of FIG. 1. FIG. 3 is a view showing a laminate structure 85 and leads 12 and 22 as seen in the ZX cross section of FIG. 1.

As shown in FIGS. 1 to 3, the lithium-ion secondary battery 100 in accordance with this embodiment is mainly constituted by a laminate structure 85; a case (package) 50 for accommodating the laminate structure 85 in a closed state; and leads 12 and 22 for connecting the laminate structure 85 to the outside of the case 50. The laminate structure 85 comprises, successively from the upper side, a positive electrode collector 15, a secondary battery element 61, a negative electrode collector 16, a secondary battery element 62, a positive electrode collector 15, a secondary battery element 63, a negative electrode collector 16, a secondary battery element 64, and a positive electrode collector 15, each having a planar form.

Secondary Battery Element

As shown in FIG. 2, each of the secondary battery elements 61, 62, 63, 64 is constituted by a planar cathode (positive electrode active material layer) 10 and a planar anode (negative electrode active material layer) 20 which oppose each other; an electrically insulating planar separator 40 disposed between the anode 10 and cathode 20 adjacent thereto; and an electrolytic solution (not depicted) which includes an electrolyte and is contained in the cathode 10, anode 20, and separator 40.

The anodes 20 in the secondary battery elements 61 to 64 are formed on their corresponding surfaces of the negative electrode collectors 16, whereas the cathodes 10 in the secondary battery elements 61 to 64 are formed on their corresponding surfaces of the positive electrode collectors 15. For convenience of explanation, the anode and cathode are determined according to polarities of the lithium-ion secondary battery 100 at the time of discharging. When charging the lithium-ion secondary battery 100, electric charges flow in a direction opposite from that at the time of discharging, whereby the anode and cathode replace each other.

Anode

Each anode 20 is a layer containing a negative electrode active material, a conductive auxiliary agent, a binder, and the like. In the following, the anode 20 will be explained.

The anode active material is not limited in particular as long as it can reversibly advance occlusion/release of lithium ions, desorption/insertion of lithium ions, or doping/undoping of lithium ions with their counter anions (e.g., ClO₄⁻), whereby materials similar to those used in known lithium-ion secondary battery elements can be employed. Examples of the materials include carbon materials such as natural graphite, synthetic graphite, mesocarbon microbeads, mesocarbon fiber (MCF), coke, glassy carbon, and sintered organic compounds; metals such as Al, Si, and Sn which can combine with lithium; amorphous compounds mainly composed of oxides such as SiO₂ and SnO₂; and lithium titanate (Li₄Ti₃O₁₂).

Preferred among those mentioned above are carbon materials. More preferred in particular are carbon materials having an interlayer distance d₀₀₂ of 0.335 to 0.338 nm with a crystallite size Lc₀₀₂ of 30 to 120 nm. The occlusion/release of lithium ions and desorption/insertion of lithium ions can be effected more efficiently when such materials are used. The carbon materials satisfying such conditions include synthetic graphite and MCF. The above-mentioned interlayer distance d₀₀₂ and crystallite size Lc₀₀₂ can be determined by X-ray diffraction.

In particular, it is necessary that the anode 20 carry 2.0 to 6.0 mg/cm² of the negative electrode active material in this embodiment. Here, the carried amount refers to the weight of the negative electrode active material per unit surface area of the negative electrode collector 16.

When the carried amount of the negative electrode active material is thus 2.0 to 6.0 mg/cm² which is smaller than that conventionally used, the anode becomes much thinner than conventional ones. Therefore, the Li concentration polarization in the anode is less likely to occur than in conventional ones, whereby lithium ions are harder to be inhibited from intercalating with the negative electrode active material even when a large current is supplied to the lithium-ion secondary battery upon rapid charging at 10 C or higher.

When the carried amount of the negative electrode active material exceeds 6.0 mg/cm² here, the intercalation tends to be inhibited by concentration polarization.

When the carried amount of the negative electrode active material is less than 2.0 mg/cm², on the other hand, the intercalating process of lithium ions at the interface between the negative electrode active material and electrolytic solution becomes a bottleneck, whereby rapider charging cannot be achieved even if the carried amount is further lowered. Also, the negative electrode active material layer becomes too thin, so that the volume occupied by the collectors in the lithium-ion secondary battery becomes too large as compared with the negative electrode active material, whereby the volume energy density becomes insufficient.

The conductive auxiliary agent is not restricted in particular as long as it ameliorates the conductivity of the anode 20, whereby known conductive auxiliary agents can be used. Examples of the conductive auxiliary agent include carbon blacks; carbon materials; fine powders of metals such as copper, nickel, stainless, and iron; mixtures of carbon materials and fine metal powders; and conductive oxides such as ITO.

The binder is not restricted in particular as long as it can bind particles of the above-mentioned negative electrode active material and conductive auxiliary agent to the negative electrode collector 16, whereby known binders can be used. Its examples include fluorine resins such as polyvinylidene fluoride (PVDF), polytetrafluoroethylene (PTFE), tetrafluoroethylene/hexafluoropropylene copolymer (FEP), tetrafluoroethylene/perfluoroalkylvinyl ether copolymer (PEA), ethylene/tetrafluoroethylene copolymer (ETFE), polychlorotrifluoroethylene (PCTFE), ethylene/chlorotrifluoroethylene copolymer (ECTFE), and polyvinyl fluoride (PVF); and styrene/butadiene rubber (SBR).

The material of the negative electrode collectors 16 binding with their corresponding anodes 20 is not restricted in particular as long as it is a metal material usually employed as an anode collector for a lithium-ion secondary battery element. Its examples include copper and nickel. Each negative electrode collector 16 extends outward so as to form a tongue 16a at an end thereof as shown in FIGS. 1 and 3.

Cathode

Each cathode 10 is a layer including a positive electrode active material, a conductive auxiliary agent, a binder, and the like. In the following, the cathode 10 will be explained.

The positive electrode active material is not limited in particular as long as it can reversibly advance occlusion/release of lithium ions, desorption/insertion (intercalation) of lithium ions, or doping/undoping of lithium ions with their counter anions (e.g., ClO₄⁻), whereby known electrode active materials can be employed. Examples of the materials include lithium cobaltate (LiCoO₂); lithium nickelate (LiNiO₂); lithium manganese spinel (LiMn₂O₄); mixed metal oxides represented by the general formula of LiNiₓCo_{y}Mn_{z}O₂ (x+y+z=1); and mixed metal oxides such as lithium vanadium compound (LiV₂O₅), olivine type LiMPO₄ (where M is Co, Ni, Mn, or Fe), and lithium titanate (Li₄Ti₅O₁₂).

The carried amount of the positive electrode active material per unit surface area of the positive electrode collector 15 can suitably be set in conformity to the amount of the negative electrode active material carried by the anode 20 as appropriate, and is preferably 4.0 to 11.0 mg/cm², for example.

For constituents other than the positive electrode active material contained in the cathode 10, materials similar to those constituting the anode 20 can be used. Electronically conductive particles similar to those in the anode 20 are preferably contained in the cathode 10 as well.

The material of the positive electrode collectors 15 binding with their corresponding cathodes 10 is not restricted in particular as long as it is a metal material usually employed as a cathode collector for a lithium-ion secondary battery element. One of its examples is aluminum. Each collector 15 extends outward so as to form a tongue 15a at an end thereof as shown in FIGS. 1 and 3.

Separator

The separator 40 disposed between the anode 20 and cathode 10 is formed from an electrically insulating porous body. The material of the separator is not restricted in particular, whereby known separator materials can be employed. Examples of the electrically insulating porous body include laminates having a film made of polyethylene, polypropylene, or polyolefin; extended films of mixtures of the resins mentioned above; and fibrous nonwoven fabrics made of at least one kind of material selected from the group consisting of cellulose, polyester, and polypropylene.

In each of the secondary battery elements 61 to 64, as shown in FIG. 3, the separator 40, anode 20, and cathode 10 reduce their areas in this order, the end faces of the anode 20 project out of the end faces of the cathode 10, and the end faces of the separator 40 project out of the end faces of the anode 20 and cathode 10.

As a consequence, even when the layers slightly deviate from each other in a direction intersecting their laminating direction because of errors at the time of manufacture and the like, the whole surface of the cathode 10 can easily oppose the anode 20 in each of the lithium-ion secondary battery elements 61 to 64. Therefore, lithium ions released from the cathode 10 are sufficiently taken into the anode 20 by way of the separator 40. When lithium ions are not sufficiently taken into the anode 20, those not taken into the anode 20 may be deposited, so that carriers of electric energy may decrease, thereby deteriorating the energy capacity of the battery. Since the separator 40 is greater than each of the cathode 10 and anode 20, and projects from the end faces of the cathode 10 and anode 20, the short-circuiting occurring when the cathode 10 and anode 20 come into contact with each other is reduced.

In particular, the separator 40 has a porosity of 45% to 90% and a Gurley air permeance of less than 200 s/100 cm³ in this embodiment

The porosity is a value obtained when the volume of the pore part of the separator is divided by the combined volume of the pore and solid parts of the separator. The porosity can be determined by a gravimetric method, for example.

On the other hand, the Gurley air permeance is the air permeance determined by JIS P8117, and is defined as a time required for 100 cm³ of air to pass through a film at a pressure of 0.879 g/mm². The Gurley air permeance indicates the easiness for the electrolytic solution to flow through the separator 40. The easiness for the electrolytic solution to flow varies depending on the structure of pores such as the size and form thereof.

Lithium ions seem to migrate favorably between the negative and positive electrode active materials at the time of charging/discharging when the separator 40 has a porosity of at least 45% and a Gurley air permeance of less than 200 s/100 cm³ as in this embodiment.

When the porosity is less than 40% and/or the Gurley air permeance is not smaller than 200 s/100 cm³, on the other hand, it seems that lithium ions are less likely to migrate efficiently between the positive and negative electrode active materials, since the amount of electrolytic solution which can infiltrate the separator 40 is too small, the electrolytic solution is harder to flow through the separator, lithium ions migrate unevenly in the separator, etc.

When the porosity of the separator 0.40 exceeds 90%, the strength of the separator 40 becomes insufficient.

Electrolytic Solution

The electrolytic solution is contained in the anode 20 and cathode 10 and pores of the separator 40. The electrolytic solution is not restricted in particular, whereby electrolytic solutions (aqueous electrolytic solutions, and electrolytic solutions using organic solvents) used in known lithium-ion secondary battery elements can be employed. However, electrolytic solutions (nonaqueous electrolytic solutions) using organic solvents are preferred, since aqueous electrolytic solutions have such an electrochemically low decomposition voltage that the durable voltage at the time of charging is limited to a low level. As the electrolytic solution for lithium-ion secondary battery elements, one in which a lithium salt is dissolved in a nonaqueous solvent (organic solvent) is employed preferably. Examples of the lithium salt include salts such as LiPF₆, LiClO₄, LiBF₄, LiAsF₆, LiCF₃SO₃, LiCF₃CF₂SO₃, LiC (CF₃SO₂)₃, LiN(CF₃SO₂)₂, LiN(CF₃CF₂SO₂)₂, LiN(CF₃SO₂) (C₄F₉SO₂), and LiN(CF₃CF₂CO)₂. These salts may be used either singly or in combination of two or more species.

As the organic solvents, those used in known lithium-ion secondary battery elements can be employed. Preferred examples include propylene carbonate, ethylene carbonate, and diethyl carbonate. They may be used either singly or in mixture of two or more species at any ratio.

In this embodiment, the electrolytic solution is not limited to a liquid, but may be a gelled electrolyte obtained by adding a gelling agent thereto. Instead of the electrolytic solution, a solid electrolyte (electrolyte made of a solid polymer electrolyte or ionically conductive inorganic material) may be contained as well.

Lead

Leads 12 and 22, each having a ribbon-like outer form, project out from within the case 50 by way of a seal part 50b as shown in FIG. 1.

The lead 12 is formed from a conductor material such as a metal. As the conductor material, aluminum or the like can be employed, for example. As shown in FIG. 3, the end part of the lead 12 within the case 50 is joined to the tongues 15a, 15a, 15a of the positive electrode collectors 15, 15, 15, whereby the lead 12 is electrically connected to the cathodes 10 by way of the respective positive electrode collectors 15.

The lead 22 is also formed from a conductor material such as a metal. Examples of the conductor material include copper and nickel. The end part of the lead 22 within the case 50 is welded to the tongues 16a, 16a of the negative electrode collectors 16, 16, whereby the lead 12 is electrically connected to the anodes 20 by way of the respective negative electrode collectors 16.

As shown in FIGS. 1 and 3, the respective portions of the leads 12, 22 held by the seal part 50b of the case 50 are covered with insulators 14 made of a resin or the like in order to enhance the sealability. Though not restricted in particular, each of the insulators 14 is formed from a synthetic resin, for example. The leads 12 and 22 are separated from each other in a direction orthogonal to the laminating direction of the laminate structure 85.

Case

The case 50 is not restricted in particular as long as it can seal the laminate structure 85 and prevent air and moisture from entering the case, whereby cases used in known lithium-ion secondary battery elements can be employed. For example, a synthetic resin such as epoxy resin or a resin-laminated sheet of a metal such as aluminum can be used. As shown in FIG. 1, the case 50 is formed by folding a rectangular flexible sheet 51C into two at substantially the longitudinal center part, and holds the laminate structure 85 from both sides of the laminating direction (vertical direction). Among end parts of the sheet 51C folded into two, the seal part 50b in the three sides excluding the folding part 50a are bonded by heat sealing or an adhesive, whereas the laminate structure 85 is sealed therewithin. The case 50 is bonded to the insulators 14 at the seal part 50b, so as to seal the leads 12, 22.

Such a lithium-ion secondary battery 300 is less likely to yield capacity deterioration after cycles of charging/discharging even when rapid charging such as constant voltage charging is performed.

The reason why the lithium-ion secondary battery of the present invention exhibits such a characteristic is not always clear. However, it seems that, for example, defining the carried amount of the negative electrode active material substantially increases the area of the active material/electrolytic solution interface, so as to lower the Li concentration polarization within the negative electrode active material, whereby lithium ions are less likely to be deposited as dendrite on the negative electrode, whereas defining the Gurley air permeance and porosity of the separator can warrant easiness in migration of lithium ions sufficiently and evenly, these facts synergistically acting to reduce the deterioration in capacity even when rapid charging is performed.

For such a lithium-ion secondary battery, charging including a step of charging with a current at a set value corresponding to 10 C. or higher, and rapid charging with constant voltage charging at 4.2 V can be performed favorably in particular.

Manufacturing Method

An example of method of manufacturing the above-mentioned lithium-ion secondary battery 100 will now be explained.

First, respective coating liquids (slurries) containing constituent materials for forming electrode layers to become the anode 20 and cathode 10 are prepared. The anode coating liquid is a solvent including the above-mentioned negative electrode active, conductive auxiliary agent, binder, and the like. The cathode coating liquid is a solvent including the above-mentioned positive electrode active material, conductive auxiliary agent, binder, and the like. The solvent used in each coating liquid is not restricted in particular as long as it can dissolve the binder and disperse the active material and conductive auxiliary agent. For example, N-methyl-2-pyrrolidone or N,N-dimethyl formamide can be used.

Next, positive electrode collectors 15 made of aluminum or the like, and negative electrode collectors 16 made of copper, nickel, or the like are prepared. Subsequently, as shown in FIG. 4, the cathode coating liquid is applied to one side of the positive electrode collector 15 and then is dried, so as to form a cathode 10. Thus formed laminate is cut out into rectangular forms each having a tongue 15a, whereby two 2-layer laminates 120 shown in FIG. 4 are obtained for both ends.

Similarly, the cathode coating liquid is applied to both sides of the positive electrode collector 15 and then is dried, so as to form cathodes 10 on both sides. Thus formed laminate is cut out into a rectangular form having a tongue 15a, whereby one 3-layer laminate 130 for a cathode is obtained.

On the other hand, the anode coating liquid is applied to both sides of the negative electrode collector 16 and then is dried, so as to form anodes 20 on both sides Thus formed laminate is cut into rectangular forms each having a tongue 16a, whereby two 3-layer laminates 140 for anodes are obtained.

Techniques employed when applying the coating liquids to the collectors are not restricted in particular, but may be determined appropriately according to the material and form of metal plates for collectors, etc. Examples of the techniques include metal mask printing, electrostatic coating, dip coating, spray coating, roll coating, doctor blading, gravure coating, and screen printing. After the coating, pressing is effected by a flat press, calender rolls, or the like if necessary.

Here, the anode coating liquid is applied such that the amount of the negative electrode active material carried by the anode 20 falls within the range of 2.0 to 6.0 mg/cm². Preferably, the cathode coating liquid is applied such that the amount of the positive electrode active material carried by the cathode 10 falls within the range of 4.0 to 11.0 mg/cm². Both faces of the tongues 15a, 16a are free of the cathode 10 and anode 20.

Here, as shown in FIGS. 3 and 4, the rectangle of the cathode 10 in each of the 2-layer laminates 120 and 3-layer laminate 130 is smaller than that of the anode 20 in each of the 3-layer laminates 140.

Subsequently, separators 40 are prepared. The separators 40 are made by cutting an insulating porous material into rectangles each greater than the rectangle of the anode 20 in each 3-layer laminate 140. Each separator 40 has a porosity falling within the range of 45% to 90% and a Gurley air permeance of less than 200 s/100 cm³.

Next, the 2-layer laminates 120, 3-layer laminate 130, and 3-layer laminates 140 are laminated so as to alternate with the separators 40 in the order of FIG. 4, i.e., in the order of 2-layer laminate 120/separator 40/3-layer laminate 140/separator 40/3-layer laminate 130/separator 40/3-layer laminate 140/separator 40/2-layer laminate 120. Thus obtained laminate is heated while being held by center parts within planes on both sides of the laminating direction, whereby the laminate structure 85 shown in FIG. 3 is obtained. Here, as shown in FIG. 4, the layers are arranged such that each separator 40 has one face in contact with the cathode 10 and the other face in contact with the anode 20.

Further, the 2-layer laminates 120, 3-layer laminates 140, 3-layer laminate 130, and separators 40 are arranged in the laminate structure such that the end faces of the 3-layer laminates 140 for anodes project out of the end faces of the 2-layer laminates 120 and 3-layer laminate 130, whereas the end faces of the separators 40 project out of the end faces of the 3-layer laminates 140.

Then, the leads 12, 22 shown in FIG. 3 are prepared, and their respective longitudinal center parts are covered with insulators 14 made of a resin or the like.

Subsequently, as shown in FIG. 3, the tongues 15a are welded to an end part of the lead 12, whereas the tongues 16a are welded to an end part of the lead 22.

This completes the laminate structure having the leads 12 and 22 connected thereto.

An example of method of making the case 50 will now be explained. First, as shown in (a) of FIG. 5, a rectangular sheet 51B in which aluminum is laminated with a thermally bondable resin layer is prepared.

Subsequently, the sheet 51B is folded along a dotted line at the center thereof into halves, which are overlaid on each other, and only the seal parts 50b, 50b in two sides are heat-sealed by a desirable seal width under a predetermined heating condition with a sealer, for example, as shown in (b) of FIG. 5. This yields a bag-shaped case 50f formed with an opening 50c for introducing the laminate structure.

Then, the laminate structure 85 having the leads 12 and 22 connected thereto is inserted into the case 50f in the state provided with the opening 50c. Subsequently, the electrolytic solution is injected into the case 50f within a vacuum container, so that the laminate structure 85 is dipped in the electrolytic solution. Thereafter, while in a state where each of the leads 12 and 22 partly projects out from within the case 50f, the opening 50c of the case 50f is sealed with a heat sealer. Here, the parts of leads 12, 22 covered with the insulators 14 are sealed while being held by the opening 50c. This completes the making of the lithium-ion secondary battery 100.

Without being restricted to the above-mentioned embodiment, the present invention can be modified in various manners.

Though the laminate structure 85 is one having four lithium-ion secondary battery elements as single cells in the above-mentioned embodiment, the number of lithium-ion secondary battery elements may be more than 4 or not greater than 3, e.g., 1, as well.

### EXAMPLES

In the following, the present invention will be explained in further detail with reference to Examples and Comparative Examples, though these examples do not restrict the present invention at all.

Here, lithium-ion secondary batteries were made by using separators having various porosity and Gurley air permeance values.

### Example 1

First, cathode laminates were made in the following procedure. Initially, LiMn_{0.33}Ni_{0.33}CO_{0.34}O₂ (where the subscripts indicate atomic ratios) as a positive electrode active material, acetylene black as a conductive auxiliary agent, and polyvinylidene fluoride (PVdF) as a binder were prepared. They were mixed and dispersed by a planetary mixer such that the weight ratio of positive electrode active material/conductive auxiliary agent/binder =90:6:4. Then, the viscosity of the resulting product was adjusted with an appropriate amount of NMP as a solvent mixed therein, whereby a slurry-like cathode coating liquid (slurry) was prepared.

Subsequently, an aluminum foil (having a thickness of 20 μm) was prepared, and the cathode coating liquid was applied thereto by doctor blading such that the carried amount of the active material became 5.5 mg/cm², and then was dried. Thus obtained product was pressed with calender rolls such that the applied cathode layer attained a porosity of 28%. The pressed product was cut out into a form having a cathode surface with a size of 23×19 mm and a predetermined tongue terminal, whereby a cathode laminate was obtained. Here, cathode laminates each having a cathode formed on only one side, and cathode laminates each having both sides formed with cathodes were made.

Next, anode laminates were made in the following manner. First, natural graphite (MSG manufactured by BTR) as a negative electrode active material, and PVdF as a binder were prepared. They were compounded such that the weight ratio of negative electrode active material/binder =95:5, and were mixed and dispersed by a planetary mixer. Then, the viscosity of the resulting product was adjusted with an appropriate amount of NMP as a solvent fed therein, whereby a slurry-like anode coating liquid (slurry) was prepared.

Next, a copper foil (having a thickness of 15 μm) as a collector was prepared, and the anode coating liquid was applied to both sides of the copper foil by doctor blading such that the carried amount of the anode active material became 3.0 mg/cm², and then was dried, whereby an anode laminate was obtained. Thus obtained product was pressed with calender rolls such that the anode layer attained a porosity of 30%. The pressed product was cut out into a form having an anode surface with a size of 23×19 mm and a predetermined tongue terminal, whereby an anode laminate was obtained. Here, anode laminates each having both faces formed with anodes were made.

Next, a porous film made of polyolefin (Hipore SV722 having a thickness of 22 μm, a Gurley air permeation time of 90 s/100 cm³, and a porosity of 52%, manufactured by Asahi Kasei Corp.) was cut out into a size of 24 mm×20 mm as a separator.

Subsequently, the anode and cathode laminates were laminated so as to alternate with separators, whereby a laminate structure including 14 layers of secondary battery elements were obtained. The laminate structure was pressed under heat from both end faces, so as to be fixed. They were laminated such that the cathode laminates each having one side formed with a cathode were arranged as the outermost layers of the laminate structure.

Next, a nonaqueous electrolytic solution was prepared as follows. Propylene carbonate (EC), ethylene carbonate (EC), and diethyl carbonate (DEC) were mixed so as to yield a volume ratio of 2:1:7 in this order, whereby a solvent was obtained. Subsequently, LiPF₆ was dissolved in the solvent such as to yield a concentration of 1.5 mol/dm³. Further, 3 parts by weight of 1,3-propane sultone were added to 100 parts by weight of the solution, whereby a nonaqueous electrolytic solution was obtained.

Then, a case formed by a bag-shaped aluminum laminate film was prepared, the laminate structure was put into the case, and the nonaqueous electrolytic solution was injected into the case in a vacuum chamber, so that the laminate structure was dipped in the nonaqueous electrolytic solution. Thereafter, still at a reduced pressure, the entrance part of the package was sealed such that each tongue terminal partly projected out of the package, and initial charging/discharging was performed, whereby a power supply including a laminated lithium-ion secondary battery having a capacity of 45 mAh was obtained.

Thus obtained lithium-ion secondary battery was subjected to charging with a constant current/constant voltage of 10 C/4.2 V and discharging alternately performed at room temperature, whereby a cycle test was carried out. The charging was terminated when the current value was lowered to 0.05 C, whereas discharging was performed at 10 C. and was terminated when the terminal voltage became 2.5 V.

### Example 2

The procedure was the same as Example 1 except that Solupor 8P07A manufactured by Teijin Solufill Co., Ltd. (having a thickness of 50 μm, a Gurley air permeation of 6 s/100 cm³, and a porosity of 85%) was used as separators.

### Example 3

The procedure was the same as Example 1 except that TF40 30 manufactured by Nippon Kodoshi Corp. (having a thickness of 30 μm, a Gurley air permeation of 4 s/100 cm³, and a porosity of 70%) was used as separators.

### Example 4

The procedure was the same as Example 1 except that Hipore H6022 manufactured by Asahi Kasei Corp. (having a thickness of 27 μm, a Gurley air permeation of 100 s/100 cm³, and a porosity of 54%) was used as separators.

### Example 5

The procedure was the same as Example 1 except that 2801 manufactured by Celgard Inc. (having a thickness of 8 μm, a Gurley air permeation of 150 s/100 cm³, and a porosity of 45%) was used as separators.

### Comparative Example 1

The procedure was the same as Example 1 except that Hipore N8416 manufactured by Asahi Kasei Corp. (having a thickness of 16 μm, a Gurley air permeation of 270 s/100 cm³, and a porosity of 40%) was used as separators.

### Comparative Example 2

The procedure was the same as Example 1 except that E09MMS manufactured by Tonen Tapyrus Co., Ltd. (having a thickness of 9 μm, a Gurley air permeation of 250 s/100 cm³, and a porosity of 37%) was used as separators.

### Comparative Example 3

The procedure was the same as Example 1 except that a PVdF microporous film (having a thickness of 30 μm, a Gurley air permeation of 4 s/100 cm³, and a porosity of 40%) obtained by phase separation was used as separators.

### Comparative Example 4

The procedure was the same as Example 1 except that K835 manufactured by Celgard Inc. (having a thickness of 12 μm, a Gurley air permeation of 200 s/100 cm³, and a porosity of 49%) was used as separators.

### Comparative Example 5

The procedure was the same as Example 1 except that 2720 manufactured by Celgard Inc. (having a thickness of 20 μm, a Gurley air permeation of 299 s/100 cm³, and a porosity of 50%) was used as separators.

### Comparative Example 6

The procedure was the same as Example 1 except that Hipore TD0072 manufactured by Asahi Kasei Corp. (having a thickness of 20 μm, a Gurley air permeation of 240 s/100 cm³, and a porosity of 45%) was used as separators.

FIG. 6 shows capacity keeping ratios of these lithium-ion secondary batteries after 100 cycles of charging/discharging. As evidenced by Examples 1 to 5, the capacity keeping ratio after 100 cycles was 90% or higher within the range where the separator had a porosity of 45% to 90% and a Gurley air permeance of less than 200 s/100 cm³. When at least one of the porosity and Gurley air permeance of the separator fails to satisfy the conditions mentioned above as in Comparative Examples 1 to 6, on the other hand, the capacity keeping ratio did not reach 90%.

1. A lithium-ion secondary battery comprising:
a positive electrode collector having a surface provided with a positive electrode active material layer containing a positive electrode active material;
a negative electrode collector having a surface provided with a negative electrode active material layer containing a negative electrode active material;
an electrically insulating porous separator; and
an electrolytic solution containing a lithium salt and infiltrating the separator;
wherein the positive and negative electrode collectors are arranged so as to oppose each other such that the positive and negative electrode active material layers hold the separator therebetween;
wherein the negative electrode active material layer carries 2.0 to 6.0 mg/cm² of the negative electrode active material;
wherein the separator has a porosity of 45% to 90%; and
wherein the separator has a Gurley air permeance of less than 200 s/100 cm³.

2. The lithium-ion secondary battery according to claim 1, wherein the positive electrode active material layer carries 4.0 to 11.0 mg/cm² of the positive electrode active material.

3. A method of charging a lithium ion secondary battery, the method comprising the step of charging the lithium-ion secondary battery according to claim 1 with a set current value corresponding to 10 C or higher.

4. A method of charging a lithium-ion secondary battery, the method comprising the step of charging the lithium-ion secondary battery according to claim 1 with a constant voltage of 4.2 V.
